(19) United States
(12) Patent Application Publication
(10) Pub. No.: US 2013/0324094 A1
(43) Pub. Date: Dec. 5, 2013

(54) IMAGE RESPONSE SYSTEM AND METHOD OF FORMING SAME

(71) Applicant: TIP SOLUTIONS, INC., Chicago, IL (US)

(72) Inventors: Michael Unetich, Chicago, IL (US); John T. Braun, Vemon Hills, IL (US); Douglas Scott Selph, Chicago, IL (US); Joshua Eidenberg, South Buffalo Grove, IL (US)

(73) Assignee: TIP Solutions, Inc., Chicago, IL (US)

(21) Appl. No.: 13/762,585

(22) Filed: Feb. 8, 2013

Related U.S. Application Data
(60) Provisional application No. 61/653,650, filed on May 31, 2012.

(51) Int. Cl. H04W 4/16

(52) U.S. Cl. CPC H04W 4/16
USPC 455/414.1

(57) ABSTRACT

A mobile communication device has a memory and a processor, the processor executing a computer program configured to perform the steps of connecting to an external mobile communication device via a network, gathering information associated with an audio communication, transmitting the information associated with an audio communication to the external mobile communication device for display on the external mobile communication device, receiving a response from the external mobile communication device, and displaying the response from the external mobile communication device on the mobile communication device.

### CROSS REFERENCE TO RELATED APPLICATIONS

This application is a claims the benefit priority of Provisional U.S. Patent Application Ser. No. 61/653,650, filed May 31, 2012, which is incorporated by reference herein in its entirety.

### BACKGROUND OF THE INVENTION

Devices capable of sending and receiving communications, such as phone calls, text messages, electronic mail, instant messaging requests, and other electronic updates and information are becoming increasingly prevalent. Such devices come in a wide variety and may be generally stationary, such as a desktop computer, TV/Set-Top box, static game console, etc., or may be easily portable, such as a smart phone, tablet computer, notebook computer, personal digital assistant (“PDA”), portable game console, portable media device, etc. Further, such devices may send and receive communications through a wide variety of wired or wireless connections, standards, or protocols, such as the Internet, an intranet, voice over internet protocol (“VoIP”), satellite, 3G, SMS, MMS, 4G, WIMAX, etc.

These devices separate text messages from phone calls such that a user can only view either an incoming caller's phone number or a text message. Further, text messages and phone calls must be initiated using separate applications. Using conventional devices, a user cannot confirm another user's availability before initiating a phone call, which can be disruptive to the user receiving a call, and those in proximity to the user receiving the call. Further, a user cannot currently notify a recipient of a call request of a topic the caller may want to discuss during the phone call.

Accordingly, a need exists for a system that will allow a user to visually confirm the topic of an incoming call before answering the call.

### SUMMARY

Various embodiments of the present disclosure include a mobile communication device having a memory and a processor, the processor executing a computer program configured to perform the steps of connecting to an external mobile communication device via a network, gathering information associated with an audio communication, transmitting the information associated with an audio communication to the external mobile communication device for display on the external device, receiving a response from the external mobile communication device, and displaying the response from the external mobile communication device on the mobile communication device.

These and other features and advantages of the present disclosure will be apparent from the following detailed description, in conjunction with the appended claims.

### BRIEF DESCRIPTION OF THE DRAWINGS

Details of the present disclosure, including non-limiting benefits and advantages, will become more readily apparent to those of ordinary skill in the relevant art after reviewing the following detailed description and accompanying drawings, wherein:

FIG. 1 illustrates a schematic representation of a mobile communication device;

FIG. 2 illustrates a schematic representation of the interaction between an application processing unit and radio communication unit in the mobile communication device of FIG. 1;

FIG. 3A depicts a dialing screen on the mobile communication device of FIG. 1;

FIG. 3B depicts a message input screen displayed on the mobile communication device of FIG. 1 after a message generation button is selected;

FIG. 3C depicts a configuration screen displayed on the mobile communication device of FIG. 1 in response to the selection of a configuration button;

FIG. 4 is an illustrative example of the process used by the mobile communication device of FIG. 1 to transmit a message with a telephone call;

FIG. 5A depicts another embodiment of a display on the mobile communication device of FIG. 1 that is configured to receive a transmission from a transmitting mobile communication device;

FIG. 5B illustrate one embodiment of an incoming call display screen on the mobile communication device of FIG. 1 that is configured to receive and display the text message and transmitting mobile communication device identification;

FIG. 5C illustrates another embodiment of an incoming call display screen on the mobile communication device of FIG. 1 that is configured to receive and display the text message and transmitting mobile communication device identification;

FIG. 6 is a schematic representation of a mobile communication device of FIG. 1 generating a message and transmitting the message to a receiving communication device;

FIG. 7 is a schematic representation of a mobile communication device of FIG. 1 receiving and processing information from a transmitting mobile communication device;

FIG. 8 is a schematic representation of the mobile communication device of FIG. 1 receiving and processing information from another mobile communication device;

FIG. 9 is a schematic representation the mobile communication device of FIG. 1 routing text to alternate display locations based on the network status of the receiving device

FIG. 10 depicts the configuration screen of FIG. 3C with the question configuration box set to respond to a communication with a camera image;

FIG. 11 illustrates a filtering screen that is displayed when a user selects the filter button;

FIG. 12 depicts one embodiment of an incoming call display screen on the receiving device; and

FIG. 13 is a schematic representation of a mobile communication device responding to a communication request with an image

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to be limited to any specific embodiment disclosed herein.

The present disclosure is directed to an application operating on a mobile communication device configured to transmit a text message simultaneously with a phone call request. A corresponding application on the receiving mobile communication device receives the text message and phone call request, extracts configuration information from the text message, and displays the phone number of the mobile communication device transmitting the text message, the text message, and response buttons which the user of the receiving device may use to respond to the text message before initiating the phone call.

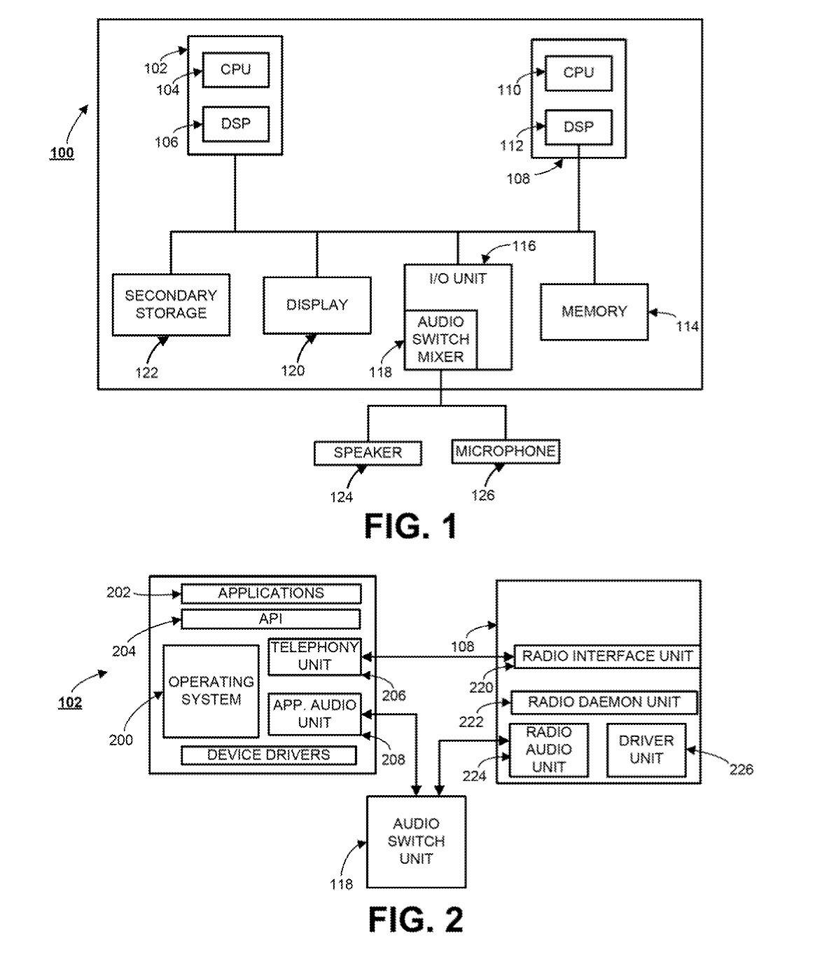

FIG. 1 illustrates a mobile communication device 100. The mobile communication device 100 includes an application processing unit 102 that includes a central processing unit (CPU) 104 and a digital signal processor (DSP) 106, a radio communication unit 108 that includes a CPU 110 and DSP 112, a memory 114, an input output (10) unit 116 that includes an audio switch unit 118, a display 120, and a secondary storage unit 122. The radio communication unit 108 is configured to communicate across a wireless network. The radio communication unit 108 may be configured to communicate over a wireless cellular network using any cellular protocol including, but not limited to, code division multiple access (CDMA), global system for mobile communications (GSM), and universal mobile telecommunications system (UMTS), or any other cellular communication protocol.

The IO Unit 116 is coupled to a speaker 124 and a microphone 126 via the audio switch unit 118. The audio switch unit 118 is configured to receive an audio signal from the microphone 126, and to adjust various characteristics of the received audio signal. The audio switch unit 118 may adjust the volume of the audio, side tone generation, comfort noise generation, echo cancelation, automatic gain, noise suppression, tone generation, or any other characteristic of the audio signal. The audio switch unit 118 also routes audio signals received by the microphone 126 to the application processing unit 102, or the radio communication unit 108, and also routes audio from the application processing unit 102 and radio communication unit 108 to the speaker 124. The mobile communication device 100 may be a transmitting device, when the device 100 is transmitting information to another mobile communication device, or a receiving device when the mobile communication device is receiving information. For purposes of this disclosure, a device initiating initial communication will be referred to as a transmitting device, and a device receiving an initial communication well be referred to as a receiving device.

FIG. 2 illustrates a schematic representation of the interaction between the application processing unit 102 and radio communication unit 108. The application processing unit 102 includes an operating system 200 running in the CPU 104 of the application processing unit 102. The operating system 200 may be any commercially available operating system including Linux, Windows Mobile, Google Android, or any other operating system capable of running on a mobile device. The operating system 200 controls the operation of the CPU 104 and DSP 106 in the application processing unit 102. An application 202 operating in the operating system 200 interacts with different components of the mobile device 100, such as the display 120, speaker 124, and microphone 126, via an application programming interface (API) 204.

The radio communication unit 108 includes a radio interface unit 220, a radio daemon unit 222, a radio audio unit 224, and a driver unit 226 operating via the CPU 110 and DSP 112. The radio audio unit 224 is communicatively coupled to the audio switch unit 118, such that the audio switch unit 118 transmits audio captured by the microphone 126 for transmission over the wireless network by radio hardware coupled to the driver unit 226. The radio audio unit 224 also transmits audio information received from the radio hardware via the driver unit 226 to the speaker 126 via the audio switch unit 118.

The radio interface unit 220 performs high level operations to initiate a connection between the mobile device 100 and another device connected to the wireless network via the driver unit 226. The radio interface unit 220 is also communicatively coupled to a telephony unit 206 in the application processing unit 102. As an illustrative example, the radio interface unit 220 may receive a command from the telephony unit 206 to initiate a phone call between two mobile devices. The radio interface unit 220 communicates with the radio audio unit 224 and driver unit 226, via the radio daemon unit 222, to connect to the wireless network and initiate a call between the two devices. The radio interface unit 220 also communicates with the telephony unit 206 to notify the telephony unit 206 that a phone call has been initiated either by the mobile device 100 or by an external device that is calling the mobile device 100. The telephony unit 206 communicates with the application 202 running in the application processing unit 102 to provide a status of the radio transmission unit 208, and to initiate actions in the radio transmission unit 108. The radio interface unit 220 also transmits data, received from the wireless network, to the telephony unit 206.

The radio audio unit 224 in the radio communication unit 108 is communicatively coupled to the audio switch unit 118, such that the radio audio unit 224 instructs the audio switch unit 118 to send audio signals from the microphone 126 to the radio audio unit 224, and to transmit audio signals from radio audio unit 224 to the speaker 124 via the audio switch unit 118. The hardware driver unit 226 is communicatively coupled to the radio hardware in the mobile device 100 such that the hardware driver unit 226 initiates a connection with a wireless network, via the radio hardware, and controls the transmission and receipt of audio signals onto and from the wireless network. The hardware driver unit 226 is communicatively coupled to the radio audio unit 224 via the radio interface unit 220 and the radio daemon unit 222, such that the radio audio unit 224 provides audio signals from the microphone 126 to the hardware driver unit 226 for transmission over the wireless network. The hardware driver unit 226 also transmits audio signals received from the wireless network to the radio audio unit 224 for transmission to the speaker 124.

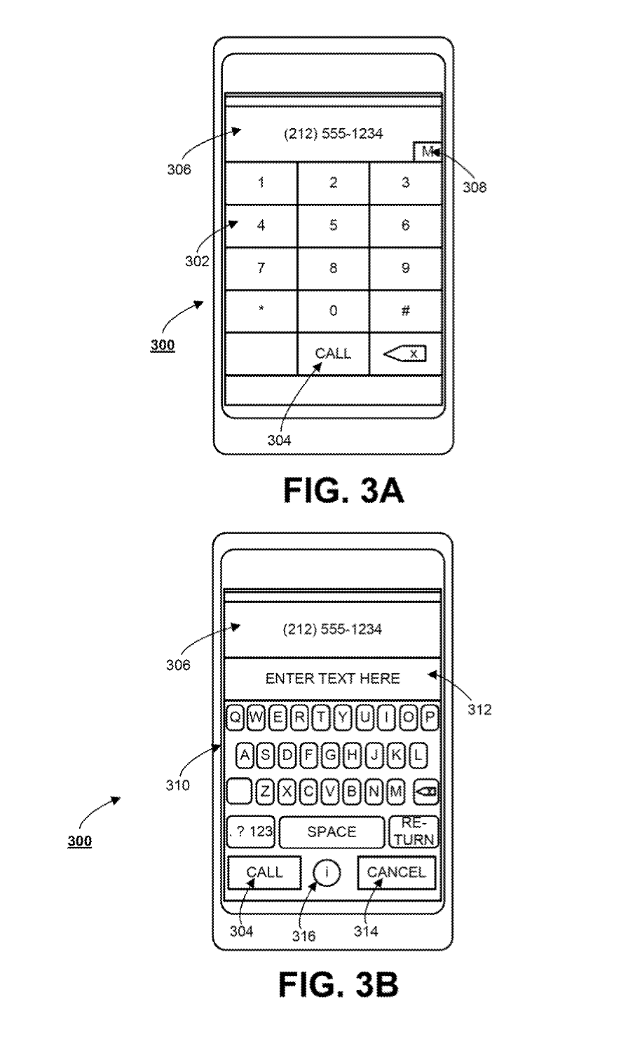

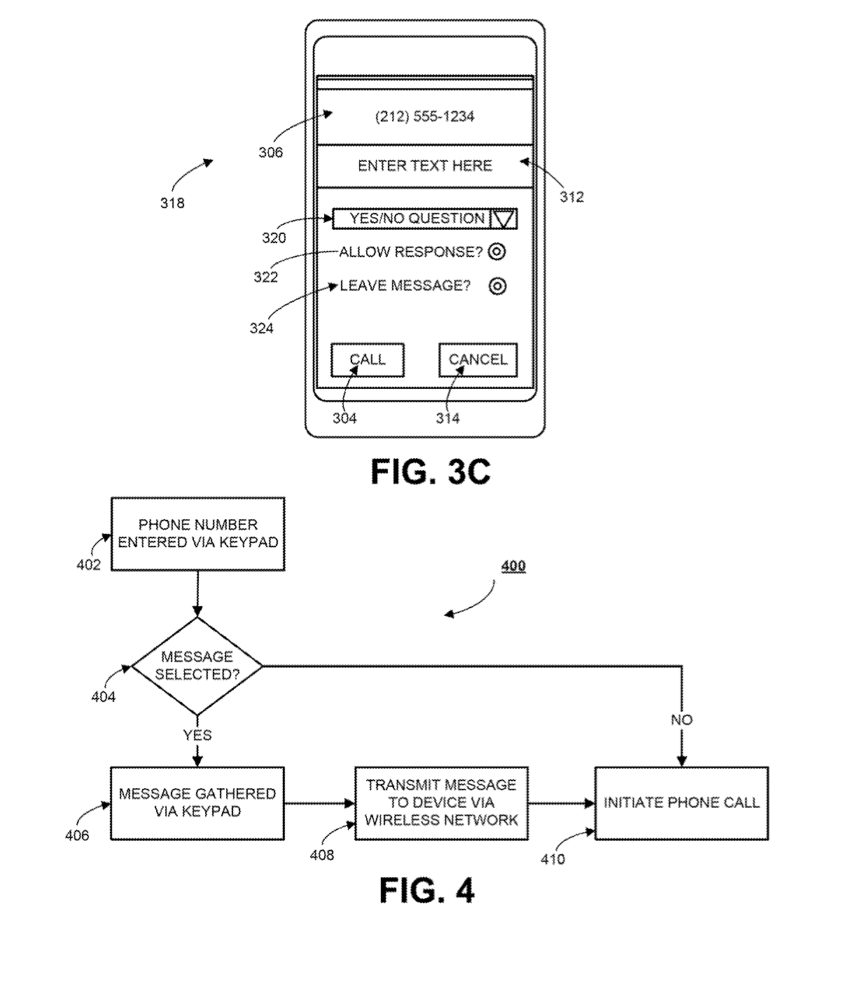

FIG. 3A depicts a dialing screen on a transmitting mobile communication device 300 that is configured to transmit information to a receiving mobile communication device. The dialing screen includes a telephonic keypad 302, a call initiation button 304, a phone number display box 306, and a message generation button 308. The dialing screen 302 allows a user to input a phone number of a receiving device that the transmitting device 300 will communicatively connect to over the wireless network. The call initiation button 304 is configured to initiate the communication between the receiving device identified by the number inputted via the telephonic keypad 302, and displayed in the phone number display unit 306, and the transmitting device 300. The message generation button 308 is configured, via the application 202, to allow a user to associate a text message with a phone call as will be described herein.

FIG. 3B depicts the message input screen displayed on the transmitting device 300 after the message generation button 308 is selected. Upon selection of the message generation button 308, a keypad 310 and a text display box 312 are displayed under the phone number display box 306. The call initiation button 304 and a message cancel button 314 are positioned on the lower portion of the dialing screen under the keypad 310. The keypad 310 may be a Qwerty type keypad or any other known keypad type. The keypad 310 is logically coupled to the text display box 312 such that keys selected on the keypad 310 are displayed in the text display box 312. Once a message is inputted into the text display box 312, the call initiation button 304 may be selected to create a communication connection as described herein. The message may also be formatted by selecting the configuration button 316.

FIG. 3C depicts a configuration screen 318 displayed in response to the selection of the configuration button 316. The configuration screen 318 includes the phone number display box 306, the text display box 312, a question configuration box 320, a response selection box 322, and a message selection box 324. The question configuration box 320 is configured to allow users to select the type of message transmitted to a receiving device, and to allow the user of the receiving device to select a pre-determined response to the transmitted message. As an illustrative example, the question configuration box 320 may allow a user to categorize the question as a YES/NO question. The receiving device will then display YES and NO buttons that will allow the receiving device to respond to the message before the phone call is initiated, as will be discussed herein. If the question type is indicated by the question configuration box 320, the application 202 operating on the transmitting device 300 will anticipate receiving one of the predetermined responses from the receiving device, and will initiate or not initiate the call based on the returned response.

As another illustrative example, a date/time question may be selected from the question configuration box 320. Selection of a date/time question will cause the receiving device to display an accept button and a date/time change button to allow the receiving device to transmit an acceptance of the proposed time or an alternate time/date as will be discussed in further detail below. The question configuration box 320 may also allow a user to configure any type of response such as, but not limited to, the selection of a geographic location, a monetary amount, or any other response that is capable of being displayed on a mobile communication device display 120.

The configuration screen also includes a response selection button 322 that allows the transmitting device 300 to respond to the selection of the receiving device. As an illustrative example, if the receiving device transmits a NO response to the transmitting device 300. Upon receiving the response, the transmitting device 300 may prompt the user of the transmitting device 300 that a response has been received, and allow the user of the transmitting device 300 to enter a new message in response to the response from the receiving device. When the response selection button 322 is selected, an indicator is included in the message sent to the receiving device notifying the receiving device that the transmitting device 300 will respond to the configuration screen and also includes a message selection button 324 that allows a user of the receiving device to leave a message if a call is connected between the transmitting device 300 and the receiving device.

FIG. 4 depicts an illustrative example of the process 400 used to transmit a message with a telephone call from the mobile communication device 100. In step 402, the phone number of the receiving device is entered via the keypad 302. In step 404, if the message generation button 308 is selected, the process moves to step 406. If the message generation button 308 is not selected, the call is initiated in step 410. In step 406, a message is gathered by the keypad 310, and the message is configured using the screens disclosed in FIGS. 3A, 3B, and 3C. In step 408, the message is transmitted to the device identified by the phone number via a wireless network connected to each mobile communication device. The message may be transmitted as a data packet, an SMS message, an e-mail message, or in any other format capable of being transmitted over a wireless network. The message may include text and configuration information with the configuration including the question type, buttons to include on the screen, a response indicator, and any other information required to properly configure the information on the receiving device display 120.

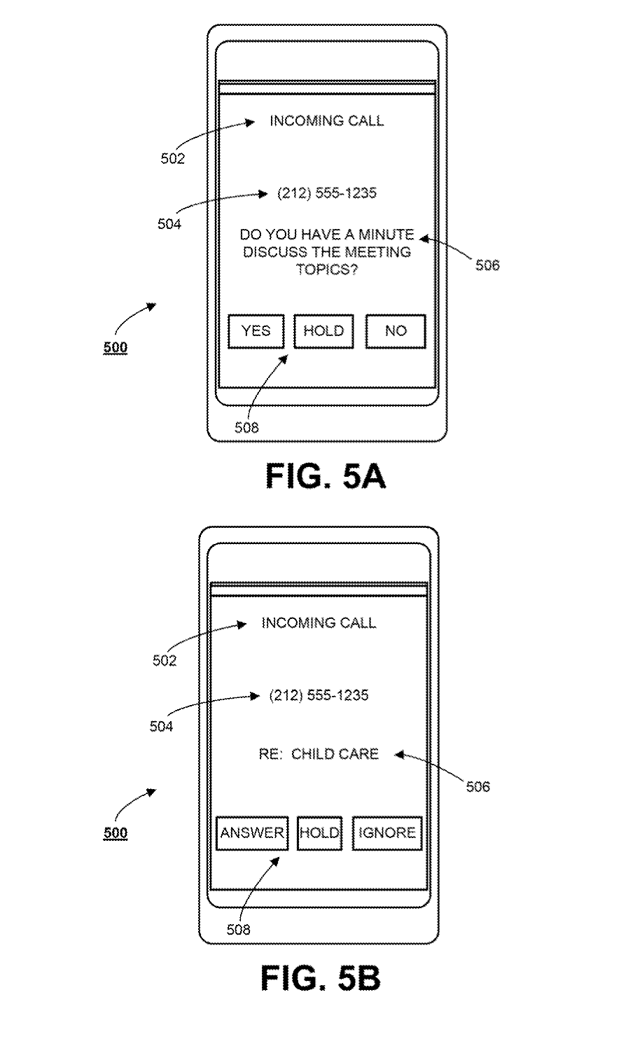

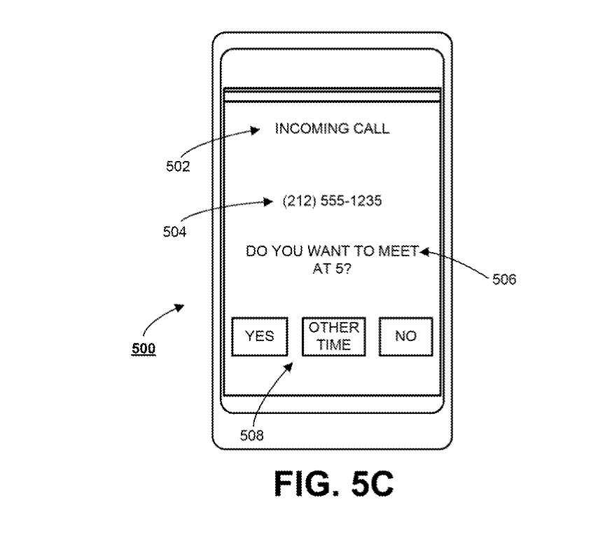

FIG. 5A illustrates another embodiment of a receiving mobile communication device 500 that is configured to receive a transmission from a transmitting mobile communication device 300. When an incoming call request is received from the transmitting device 300, the receiving device 500 displays the notification on the display 120 via a notification box 502. The phone number associated with the transmitting device 300 is displayed in the phone number receiving box 504. In addition, the text entered into the text display box 312 of the transmitting device 300 is displayed in the message display box 506. A plurality of buttons 508 may be displayed under the notification box 502. The buttons 508 may allow a user of the receiving device 500 to place the call on hold, answer the call, or send the call to voice mail by ignoring the call. The buttons 508 may also allow the user of the receiving device 500 to transmit an audio message indicating that they are not available and confirming they have received the call.

FIG. 5B depicts another embodiment of an incoming call display screen on the receiving device 500 that is configured to receive and display the text message and transmitting device 300 identification. A plurality of buttons 508 may be displayed under the message display box 506 that include a listing of predetermined responses to the question presented. As an illustrative example, if the message indicates a yes/no question, the transmitting device 300 may instruct the application on the receiving device 500 to display “YES” and “NO” buttons. If the user of the receiving device 500 selects the “YES” button, the application 202 operating on the receiving device 500 may automatically connect the audio path between the transmitting device 300 and the receiving device 500 via the audio switch unit 118.

If the user selects “NO,” the application 202 may transfer the call to voice mail, end the call, or allow the transmitting device 300 to input additional message details. If the user selects “HOLD” the application may connect the call, but not initiate audio communication until the “HOLD” button is pressed a second time.

FIG. 5C illustrates one embodiment of an incoming call display screen on a receiving device 500 that is configured to receive and display a text message and transmitting device 300 identification. The configuration of the display screen is similar to the display screen of FIG. 5B, however, the buttons 508 allow a user to respond to the message in the display box 506 by proposing a new time and date. Selection of a “YES” button may cause the application 202 on the receiving device 500 to generate a meeting notice to the transmitting device 300 and receiving device's 500 e-mail/scheduling software. As an illustrative example, the display may include a button 508 that transmits a message accepting the meeting time to the transmitting device 300 and also creates a meeting event in a Microsoft Office, Google Gmail, or any other scheduling software, and transmits the meeting notice to an e-mail address associated with the transmitting device 300 in the receiving device's 500 contact list. Further, the selection of “OTHER TIME” button may allow the user of the receiving device 500 to transmit an alternate time to the transmitting device 300. The selection of the “OTHER TIME” button may also transmit a predetermined message to the transmitting device 300 to propose a new time.

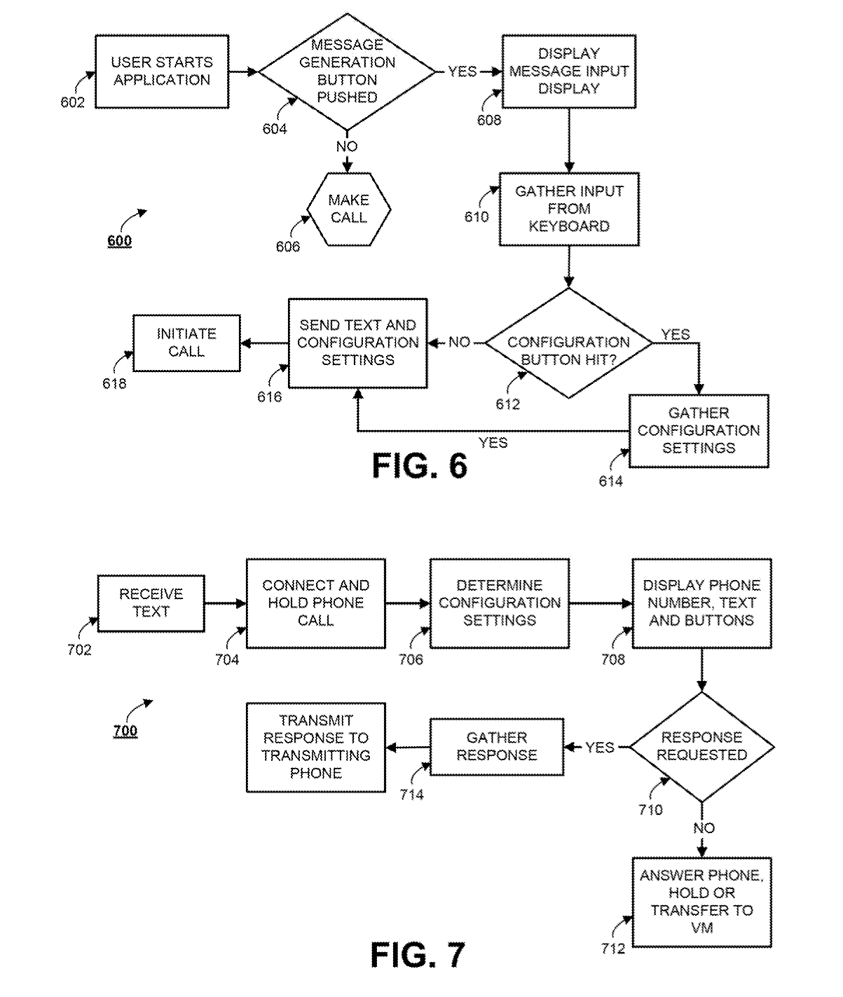

FIG. 6 depicts a schematic representation 600 of the transmitting device 300 generating a message, and sending the message to a receiving device 500. In step 602, the application 202 is started on the transmitting device 300, and a display including a telephonic keypad is displayed. In step 604, the application 202 determines if the message generation button 308 has been selected. If the message generation button 308 has not been selected, the application 202 initiates a phone call to the phone number inputted into the phone number display box 102 via the telephony unit 206 and the radio interface unit 220, in step 606. If the message generation button 308 has been selected, the application 202 displays the message input display screen on the transmitting mobile device 300 in step 608. In step 610, the message is gathered via the keypad 302 on the message input display screen.

In step 612, the application 202 determines whether the configuration button 316 has been selected. If the configuration button 316 is selected, the application displays the configuration screen depicted in FIG. 3C, and gathers the configuration settings for the communication in step 614, before moving to step 616. If the configuration has not been selected, the process moves to step 616 where the text and configuration settings are transmitted to the receiving device 500. In step 618, a telephone communication request is transmitted to the receiving device 500. One having ordinary skill in the art would appreciate that the transmission of the telephone communication request may occur before the transmission of the configuration settings and text, simultaneously with the transmission of the configuration settings and text, or after the transmission of the configuration settings and text.

FIG. 7 depicts a schematic representation 700 of the receiving device 500 receiving and processing information from a transmitting device 300. In step 702, an application 202 operating on the receiving device 500 receives information from the transmitting device 300. The information may be a data packet, an SMS message, an e-mail message, or in any other format capable of being transmitted over a wireless network. In step 704, the receiving device 500 receives an telephone communication request from the transmitting device 300, and the receiving device 500 connects the call without opening the audio channel between the transmitting device 300 and the receiving device 500 via the audio switch unit 118 in the receiving device 500. In step 706, the application 202 operating on the receiving device 500 extracts the configuration information from the received information. In step 708, the application 202 displays the phone number of the transmitting device 300, the received text information, and any buttons 508 based on the extracted configuration settings on the display 120 of the receiving device 500.

In step 710, the application 202 determines if a response has been requested from the transmitting device 300. If a response has not been requested from the transmitting device 300, in step 712, the application 202 connects the audio path between the transmitting device 300 and the receiving device 500 via the audio switch unit 118 in the receiving device 500, terminates the call, or connects the audio stream to a voice message system via the audio switch unit 118. If a response has been requested, in step 714, the application 202 gathers a response from the user of the receiving device 500 via the buttons 508. In step 716, the receiving device 500 transmits the response to the transmitting device 300.

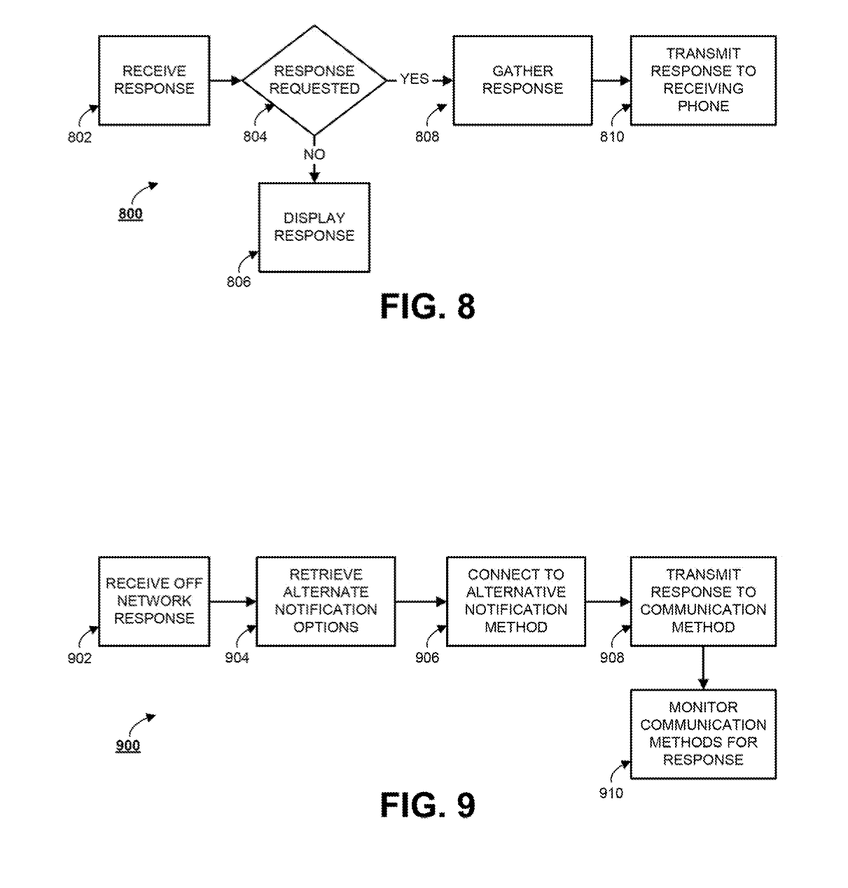

FIG. 8 is a schematic representation 800 of the transmitting device 300 receiving and processing information from the receiving device 500. In step 802, the application 202 operating on the transmitting device 300 receives a response from the receiving device 500.

In step 804, the application 202 determines if a response is requested from the receiving device 500. In step 806, if no response is requested, the application 202 displays the response from the receiving device 500. In step 808, if a response is requested from the receiving device 500, the application 202 gathers the response using any of the previously discussed methods. In step 810, the application 202 transmits the response to the receiving device 500.

FIG. 9 is a schematic representation 900 of the transmitting device 300 routing text to alternate display locations based on the network status of the receiving device 500. In step 902, the transmitting device 300 receives an off network indicator indicating the receiving device 500 is not connected to the wireless network, or that the receiving device is unavailable. The transmitting device 300 may receive the off network indicator as a message from a secondary device on the wireless network, such as the wireless management system. In step 904, the application 202 on the transmitting device 300 may retrieve alternate notification options from the contact information stored in the memory of the transmitting device 300, or an external device. The contact information may include information on the user associated with the receiving device, such as alternate phone numbers, social media web site locations, instant messaging accounts, or any other communication method. In step 906, the application 202 connects to at least one of the communication methods associated with the receiving device 500.

In step 908, the application 202 transmits the text to each connected alternative communication method. In step 910, the application monitors each connected alternative communication method for a response to the text, or for confirmation the text was delivered to the user of the receiving device.

As an illustrative example, the transmitting device 300 may connect to a Facebook account, a Google GChat account, or a Twitter account using an account established by the user of the transmitting device 300. Once each connection is established, the user may transmit the text of the message to each user account using acceptable transmission methods of each account such as posting on a wall in Facebook, sending a Tweet in Twitter, or initiating a GChat conversation. The transmitting device 300 may also transmit an e-mail message to an e-mail account of the user of the receiving device 500. Once the information has been posted, the transmitting device monitors each site and account for a response by the user. When a response is received, the response is displayed on the screen using any of the previously discussed methods.

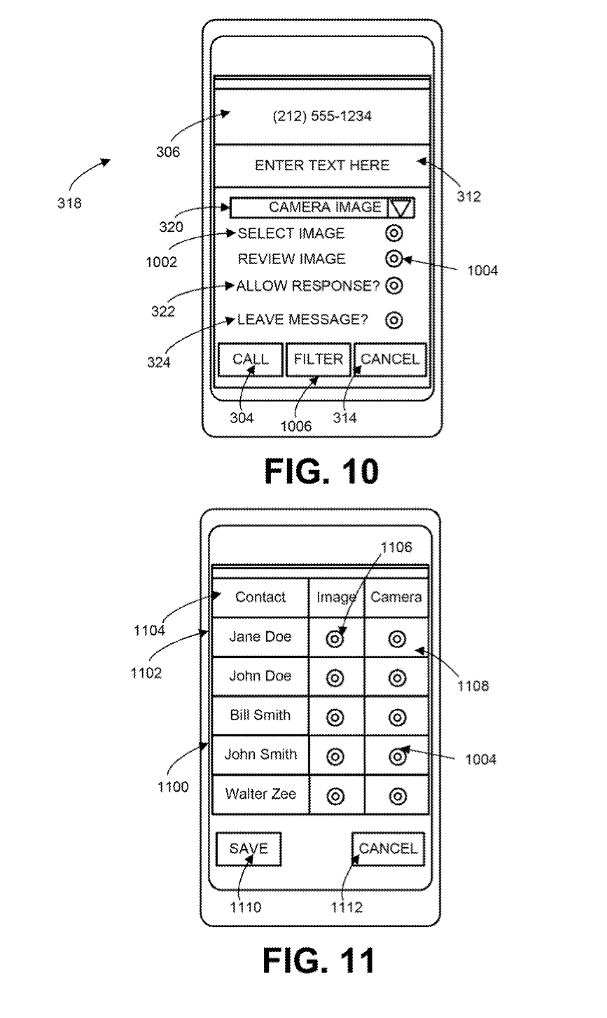

FIG. 10 depicts a configuration screen 318 of FIG. 3C with the question configuration box 320 set to respond to a communication request with a camera image. Consistent with this embodiment, the mobile communication device 100 may include an image capturing unit, such as a camera, that is coupled to the IO unit 116 of the mobile communication device 100. The image capture unit may be a standard camera, such as a Complementary metal-oxide-semiconductor (CMOS) or a Charge Coupled Device (CCD) camera on a cellular phone. The image capture unit may be capable of capturing and storing both fixed images and video images in a digital format. The term “image” is used herein to include a fixed image or a video image stored in a digital format. A fixed image may be stored in any digital image format including, JPEG, BMP, TIF, GIF, PNG or any other fixed image format. A video image may be stored in any digital video format including MP3, MPEG, AVI or any other video format.

When the configuration box 320 is set to the “CAMERA IMAGE” the application 202 operating on the mobile communication device 100 sends a request to the camera to capture an image at the time the communication request is received. The configuration screen 318 includes a select image button that allows a user to select an image using the camera 1002 and a review image button 1004 that allows a user to review an image before it is sent over the network. The image may be sent along with a text message, or may be sent as only an image. The configuration screen 318 may include a filter button 1006 that allows a user to select different response options for different contact address stored on the mobile communication device 100. The configuration screen 318 may also include an option to capture a digital video as the captured image.

FIG. 11 depicts a filtering screen 1100 that is displayed when a user selects the filter button 1006 on the configuration screen 318. The filtering screen 1100 includes a listing of the contacts 1102 stored in the memory 114 of the mobile communication device 100. Each contact includes an identification field 1104, an image button 1106 and a camera button 1108. The identification field 1104 displays the name associated with the contact 1102 that is stored in the memory 114 of the mobile communication device 100. Selecting the image button 1106 allows the user to select a stored image to send to the address associated with the contact name when a communication request from the contact is received. Selecting the camera button 1108 allows the user to send an image taken from the camera in the mobile communication device 100 in response to a communication request form the contact. If the image button 1106 and camera button 1108 are not selected, no image is transmitted. The filtering screen 1100 includes a save button 1110 to allow a user to save the configuration of the contacts and a cancel button 1112 that allows a user to cancel their changes.

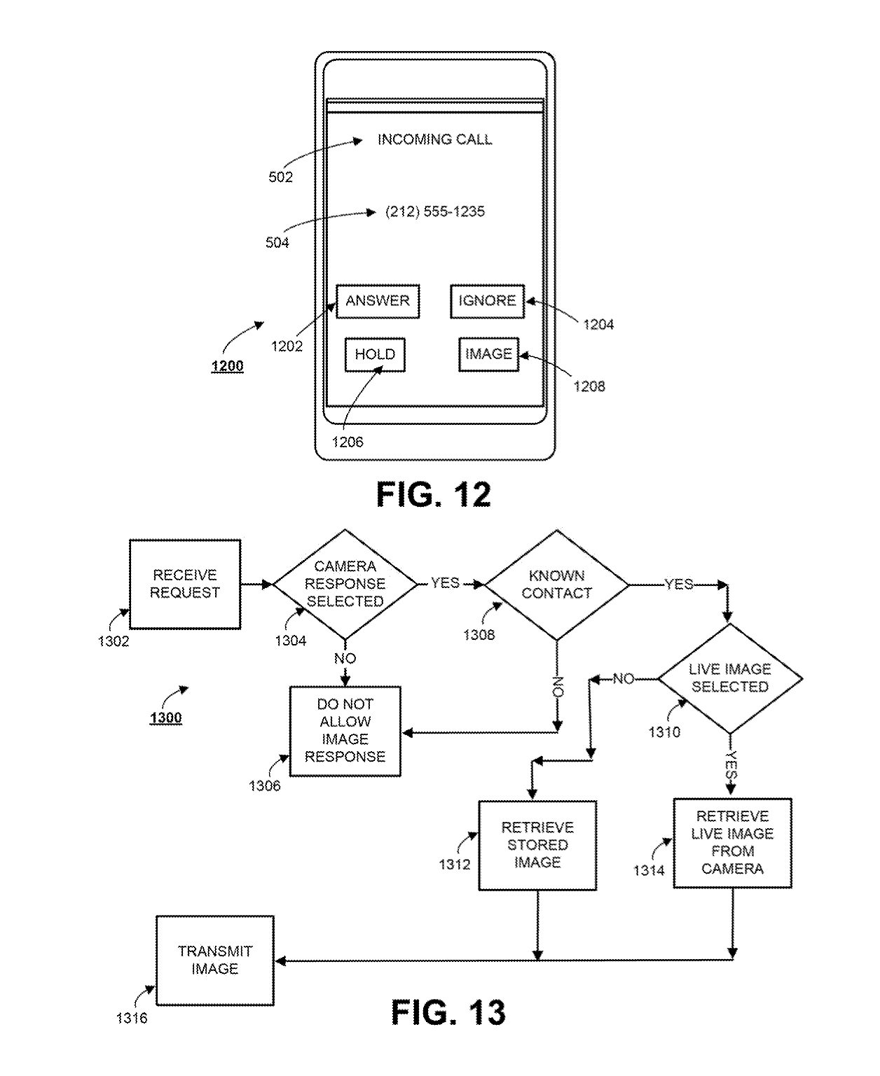

FIG. 12 depicts one embodiment of an incoming call display screen 1200 on the receiving device 500. The incoming call display screen 500 includes an answer button 1202, an ignore button 1204, a hold button 1206 and an image button 1208. Selecting the answer button 1204 opens a communication channel with the requesting device. Selecting the ignore button 1204 does not open a communication channel with the requesting device and transfers the communication request to a voice messaging system. Selecting the hold button 1206 opens a communication channel with the requesting device without opening an audio channel between the mobile communication device 100 and the requesting device to allow a user to open an audio channel at a later time while still connecting the mobile communication device 100 to the requesting device. Selecting the image button 1208 connects the mobile communication device 100 to the requesting device and retrieves an image, or a video, captured from the camera or sends a preselected image, or video, to the requesting device based on the configuration of the requesting device.

FIG. 13 is a schematic representation of a mobile communication device 100 responding to a communication request from a requesting device with an image or video. In step 1302, the mobile communication device 100 receives a communication request. The communication request may be a request to connect an audio communication path between the requesting device and the mobile communication device 100, a request to receive a text message, an e-mail, an Internet gaming request or a request for an online chat via a program such as Yahoo Messenger, GChat or any other online messaging application. In step 1304, the application 202 on the mobile communication device 100 determines whether to respond to a communication request with an image based on the configuration of the application 202. If the application 202 is configured to respond to a communication request with an image, the process proceeds to step 1308. If the application 202 is not configured to respond to a communication request with an image, the process moves to step 1306 where the application 202 presents other options for responding as described previously. In step 1308, the application 202 determines if the incoming communication is from a known contact. If the incoming communication is from a known contact, the process moves to step 1310. If the incoming communication is not from a known contact, the process moves to step 1306 where the application 202 presents other options for responding as described previously.

In step 1310, the application 202 determines whether to transmit a live image or a saved image based on the configuration associated with the user. If a live image is associated with the contact, the application 202 retrieves an image from the camera on the mobile communication device 100 in step 1312. The application 202 may retrieve the image by notifying the user of the incoming communication request, presenting the user with a button to capture an image via the camera and capturing the image after the user has selected the image to capture via the camera. The application 202 may allow the user to approve the image before transmitting the image, and may also allow the user to retake an image via the camera. In another embodiment, the application 202 may automatically take an image via the camera and send the image to the requesting device. Consistent with this embodiment, the application 202 may review the image to confirm the image exists in the memory 114 of the mobile communication device 100. The application 202 may analyze the image to determine the percentage of pixels in the image that are black. If the image contains more than a predetermined number of black pixels, the image will be identified as an overly dark image and will not be transmitted. In yet another embodiment, the application 202 may present the user with a timer that counts down to zero giving the user a predetermined amount of time to capture an image via the camera. If a stored image is associated with the contact, the application 202 retrieves the stored image file form the memory 114 or secondary storage 122 of the mobile communication device 100 in step 1314. After the image is retrieved or captured, the application 202 transmits the image over the network 108.

As an illustrative example, the mobile communication device 100 may receive a communication request from a social networking site, such as Twitter. The mobile communication device may respond to the communication request by automatically posting an image captured from the camera onto the social networking web site as a “Tweet.” The mobile communication device 100 may post the captured image on other social media or social networking web sites such as Facebook and Instagram. In another embodiment, the communication request may include a request that multiple images be transmitted over a predetermined period of time. The application 202 may receive the request and alert the user that a request for multiple image captures has been requested. If the user accepts the request, the application 202 may transmit multiple images over the predetermined period of time.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. A mobile communication device having a memory and a processor, the processor executing a computer program configured to perform the steps of:
receiving a communication request from a requesting device communicatively coupled to the mobile communication device via a network;
communicatively coupling the mobile communication device with the requesting device;
determining if the requesting device is a known device;
capturing an image from an image capture unit in the mobile communication device if the requesting device is a known device; and
transmitting the captured image to the requesting device.

2. The device of claim 1 wherein the mobile communication device displays an option to capture an image via an image capture unit or to retrieve an image from the memory.

3. The device of claim 1 wherein the communication request is a request to open an audio communication channel with the requesting device.

4. The device of claim 1 wherein an application on the mobile communication device associates an action of automatically transmitting a stored image or transmitting a captured image to the requesting device based on a user input.

5. The device of claim 4 wherein the application displays the captured image on the mobile communication device before transmitting the image to the requesting device.

6. The device of claim 1 wherein the device retrieves an image from the memory based on the identified contact and transmits the retrieved image to the requesting device.

7. The device of claim 1 wherein the requesting device is a computer connected to a social networking website.

8. The device of claim 1 wherein multiple images are captured and transmitted to the requesting device.

9. The device of claim 1 wherein the image is transmitted over the Internet.

10. The device of claim 1 wherein the image is transmitted over a cellular network.

11. A mobile communication device including:
a receiving unit that receives a communication request from a requesting device communicatively coupled to the mobile communication device via a network;
a network interface unit that communicatively couples the mobile communication device with the requesting device;
an application unit that determines if the requesting device is a known device:
an image capturing unit that captures an image if the requesting device is a known device,
wherein, the captured image is transmitted to the requesting device by the application unit via the network interface unit.

12. The device of claim 11 including an information gathering unit that gathers user information to determine if the application should transmit the captured image.

13. The device of claim 11 wherein the communication request is a request to open an audio communication channel with the requesting device.

14. The device of claim 11 wherein the application unit associates an action of automatically transmitting a stored image or transmitting a captured image to the requesting device based on a user input gathered by the information gathering unit.

15. The device of claim 14 wherein the application displays the captured image on the mobile communication device before transmitting the image to the requesting device.

16. The device of claim 11 wherein the application unit retrieves an image from a memory in the mobile communication device based on the identified contact and transmits the retrieved image to the requesting device via the network interface unit.

17. The device of claim 11 wherein the requesting device is a computer connected to a social networking website.

18. The device of claim 1 wherein multiple images are captured and transmitted to the requesting device.

19. The device of claim 11 wherein the image is transmitted over the Internet.

20. The device of claim 11 wherein the image is transmitted over a cellular network.
